(19) United States
(12) Patent Application Publication
(10) Pub. No.: US 2009/0112614 A1
(43) Pub. Date: Apr. 30, 2009

(54) ELECTRONIC SYSTEM AND METHOD FOR HEALTH MANAGEMENT

(75) Inventor: Manuel Jorge Vaz da Cunha Guimaraes, Braga (PT)

Correspondence Address: ABELMAN, FRAYNE & SCHWAB, 666 THIRD AVENUE, 10TH FLOOR, NEW YORK, NY, 10017, US

(73) Assignee: ALERT LIFE SCIENCES COMPUTING S.A., Porto (PT)

(21) Appl. No.: 11/927,227

(22) Filed: Oct. 29, 2007

(51) Int. Cl. G06Q 50/00; G06F 17/00

(52) U.S. Cl. 705/2

(57) ABSTRACT

An electronic healthcare management system handles all relevant aspects of providing healthcare services. The system integrates workflow principles to interconnect all the different elements and persons involved in the process. The system uses personal computers with touch screen monitors and personal mobile devices which communicate via radio communication technologies throughout the healthcare facilities. Facility management, clinical practice, administrative activities and management tools are integrated into a single system.

### NOTICE OF COPYRIGHT AND AUTHORIZATION OF REPRODUCTION

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

1. Field of the Invention

This invention relates to operational management of healthcare facilities, such as hospitals, clinics and other healthcare centers, and more specifically to filly integrated electronic management systems for the healthcare sector.

2. Description of the Related Art

The continuing growth of the healthcare system, fuelled by an expanding population and increased awareness and preoccupation with health related issues, creates complicated problems for healthcare managers and clinical directors. The need to ensure the delivery of efficient healthcare services while avoiding and mitigating medical errors has lead to the creation and adoption of different types of computer based tools geared specifically to the healthcare sector.

Such tools include electronic health record systems, patient encounter systems, emergency department information systems, medical decision support tools, patient tracking systems, and bed occupation systems.

Electronic health record systems aim to adapt the traditional paper based patient medical chart to an electronic environment, providing access from different locations within a healthcare facility and facilitating analysis of medical information and treatment orders. These systems streamline the data gathering process and provide standardization of the collection, storage, and presentation of medical information.

Patient encounter systems assist physicians in documenting the different aspects involved in the interaction between a physician and the patient, such as recording the patient's medical history, conducting a physical examination, making a diagnosis, and ordering a treatment plan. Patient encounter systems differ from electronic health systems insofar as their function is not limited to the creation and use of a patient record but enable interaction with other services such as laboratory and imaging departments as well as the pharmacy, in addition to monitoring patient locations and bed management.

Emergency department information systems seek to automate and integrate the several phases of care within an emergency department such as patient registration, triage, patient tracking, order entry, and related documentation.

Medical decision support tools integrate electronic health record systems with clinical information by flagging errors, contradictory symptoms, or diagnoses, and by suggesting questions, diagnoses, tests, and treatments.

Patient tracking systems allow the healthcare provider to control the locations of its patients within its facilities. Bed management systems monitor usage of beds and permit planning of bed resources.

Non-health specific software systems such as accounting, billing, customer relation management, and enterprise resource planning are also widely used, with varying degrees of integration with health specific applications.

Some of these systems aim to incorporate several aspects of healthcare services. This reveals one of the important limitations of such systems. The underlying complexity of healthcare currently prevents the known systems from incorporating all the relevant clinical aspects of healthcare and from integrating relevant enterprise management aspects of providing this type of services.

As a result, these prior art systems are inefficient in providing the desired improvements in the quality of care, in reducing patient waiting time, in avoiding medical errors and in interacting with generic enterprise management tools.

The complexity of the clinical aspects of providing healthcare services results from several factors, including a multiplicity of different medical specializations subject to different applicable documentation needs, guidelines, and protocols. Documentation of the patient encounter is also increasingly subject to strict requirements determined by different regulatory entities.

Additionally, there is frequently a disconnect between the healthcare facility, the physicians, and the patients. A physician normally works in more that one facility, such as hospitals, clinics and private physician facilities. Likewise, patients use more than one facility. These facilities may be operated by different entities, generating a multiplicity of health records.

Furthermore, the need to interact with third parties responsible for paying health services, such as insurance companies, Medicare, and Medicaid, and the prevalence of multiple and sometimes contradictory terminologies present complicated compatibility and interoperability challenges.

Compatibility and interoperability are relevant, as known systems rely on separate databases. This type of configuration impairs the use of such tools for management purposes, such as accounting for all aspects of the continuum of care including costs, timeliness of response, quantity of products and, consumables used.

The current systems are frequently too specific to certain medical areas or to certain healthcare services. For instance, the whole spectrum of intervening professionals such as physicians, nurses, managers, ancillary staff, pharmacists, laboratory technicians, imaging technicians, administrative staff, and case managers, is not able to use and benefit from the system.

Additionally, the whole spectrum of intervening professionals does not interact in a seamless and integrated manner. Even when certain processes are automated, often data is still printed and then delivered to another professional which is not connected to or which does not use the system.

A different problem results from the need to make the health records available to the corresponding patients. This trend is related to the described disconnect and is enhanced by patient mobility.

Another problem that is caused by certain attempts to deal with the underlying complexity is the dehumanization that may result from automating processes related to the provision of healthcare services. The humane nature of care is an essential element of health services.

Hence, there is a great need within the healthcare sector for a computer implemented operational management tool that is able to support all the services involved in providing health services and allows all intervening professionals to interact in an efficient manner while ensuring the provision of humane healthcare services.

### BRIEF SUMMARY OF THE INVENTION

The current invention is a computer implemented system and method for supporting the provision of healthcare services. It is directed at incorporating all aspects involved in the provision of services in effect functioning as a structure for the provision of healthcare.

In this sense, the invention is adequate for use in a variety of healthcare facilities, such as hospitals, clinics, primary care centers, and private physician facilities, and by different healthcare providers, whether integrated or not, in regional, national, international, or local healthcare systems.

The invented system includes the participation of all healthcare professionals including physicians, nurses, ancillary staff, pharmacists, laboratory technicians, imaging technicians, administrative staff, management, and case managers in accordance with predefined user profiles.

The system uses certain standard hardware components and proprietary software. The devices used are at least a personal computer, a touch screen monitor, a keyboard, a pointing device, devices that are able to receive and communicate data using radio frequencies, a biometric reader, a bar code reader, a server, a printer, a scanner, and a portable device that receives data by radio frequencies.

The system may also include a device able to record and process human voice as an alternative way of interacting with its users.

The system also includes unique identification and tracking of all individuals such as healthcare professionals and patients by way of identifiers such as bar code bracelets and biometric identification devices, with the possibility of containing integrated radio frequency capacity. These identifiers may include biosensors enabling remote monitoring of physiological parameters in an integrated manner. The unique identification extends to biomaterials collected from patients.

The system includes a graphical user interface. This interface is used for all aspects of system interaction, principally by use of a touch screen, but a keyboard and a pointing device are used for specific functions. The graphic interface presents at all time both a photograph of the healthcare professional logged on to the system and of the patient, for assisting in maintaining the humane character of healthcare, and preventing misidentification of the patient.

The method also includes user profile specific work environments for interaction of different types of users based on workflow principles and their professional attributes in different locations. The different users have different roles and their interaction is organized according to workflows.

The system uses electronic template based documentation for patient encounter functions.

The system also includes an electronic health record viewer which allows the physician to consult at all times on the same screen of the user interface a summary of the patient's electronic health record including previous interventions, medical history, diagnoses, and treatment plans. The electronic health record viewer enables the updated and complete disclosure of patient data to the patient.

The system also includes a data warehouse providing for integrated data analysis and data mining for management purposes.

The method also includes the emission and receipt of data via radio frequencies to and from fixed and portable devices.

The method includes the sequential handling of all aspects of a patient encounter by the emission and receipt of alerts to and from devices during the different stages of patient encounters and amongst the different users. The interventions are registered in the system by the users, such as physicians, nurses, and laboratory technicians, and each intervention may trigger an alert regarding the next step in the sequence.

The different applications of the system interact in the form of networks within and beyond the facilities of the healthcare provider. In this sense, the use of the system is not limited to a specific provider or to specific geographic locations, and can accompany the different interactions of a single patient and/or of a single healthcare professional with multiple healthcare providers. This method facilitates making health records available to the corresponding patients.

The method also includes the integration with non-health specific enterprise modules such as billing, customer relationship management, accounting, and enterprise resource planning as well as to legacy systems by the use of standards such as the Digital Imaging and Communications in Medicine (DICOM) standard and the Health Level Seven, Inc. (HL7) system in accordance with Integrating the Healthcare Enterprise (IHE) directives.

### BRIEF DESCRIPTION OF THE SEVERAL VIEWS OF THE DRAWINGS

FIG. 1 is an illustration showing the health management system disclosed herein.

FIG. 2 is an example of a healthcare professional workstation.

FIG. 3 is an illustration of an electronic bracelet.

FIG. 4 is an example of the graphic user interface of the system.

FIG. 5 is an illustration of the electronic health record viewer.

FIG. 6 is an illustration of the workflow principles of the system.

### DETAILED DESCRIPTION OF THE INVENTION

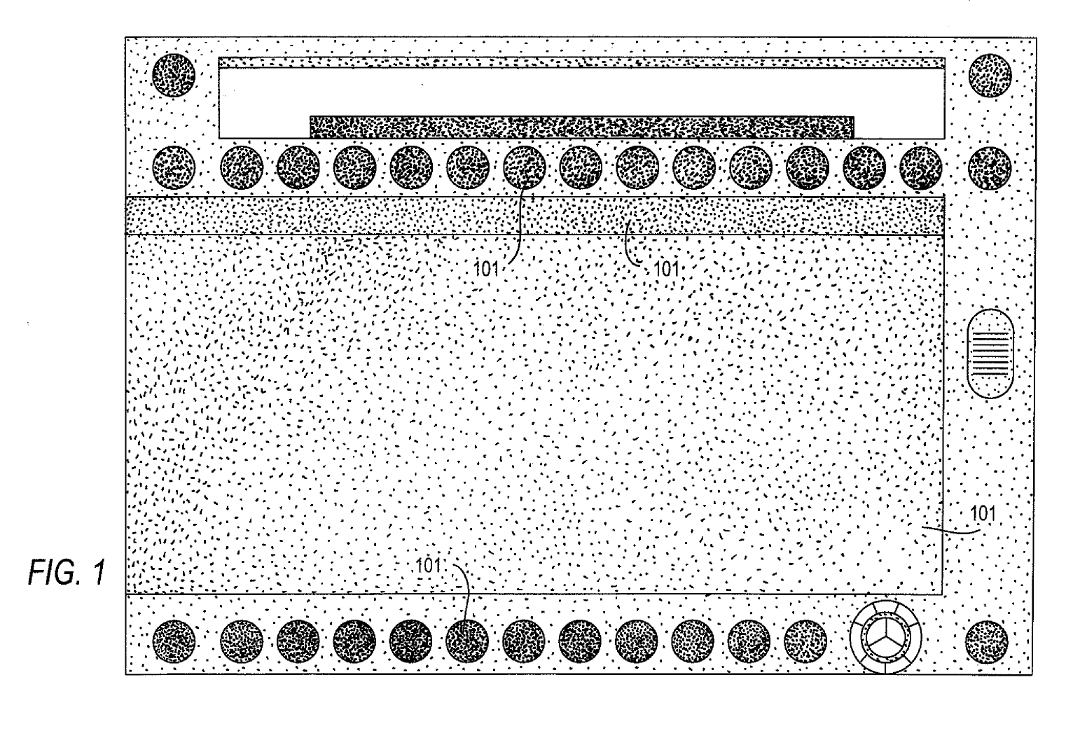

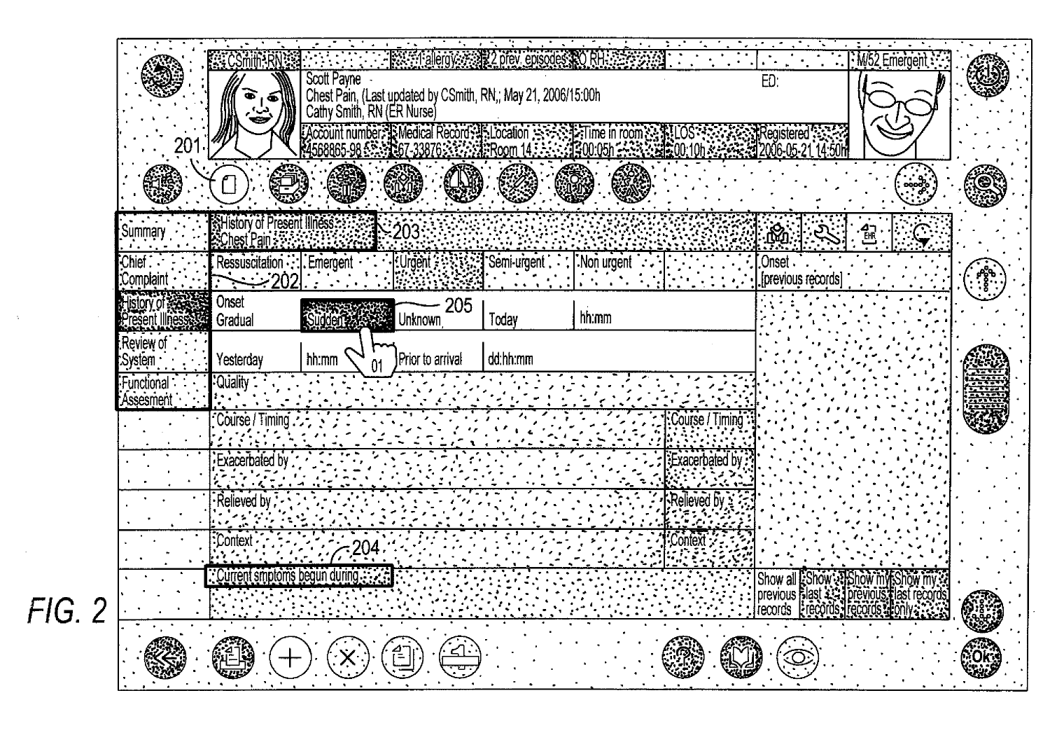

Referring to FIGS. 1-6, the present invention provides an electronic system and method for health management, in which FIG. 1 illustrates the electronic health management system disclosed herein. The system is connected to a communications network 101, such as a local area network (LAN) and/or a wide area network (WAN) or other types of networks. The principal hardware components of the electronic health management system are servers 102 and personal computers (PCs) 103, 104 with displays, such as touch screen monitors, such as the monitors 201 shown in FIG. 2.

The present invention may also include a computer readable medium 114, such as a portable memory device for installing and/or operating the present invention using the processor of any of the servers 102 or personal computers 103, 104. The computer readable medium may be accessed and read by any known computer readable medium reader, such as a disk drive or memory reader known in the art, electronically or electromagnetically connected to any of the servers 102 or personal computers 103, 104, such as by wired and/or wireless connections. The computer readable medium 114 may also include the health records, and may optionally be included in a memory of any of the servers 102 or personal computers 103, 104.

The servers 102 house the data warehouse. The personal computers 103, 104 with touch screen monitors are the principal user interface with the system. The personal computers 103, 104 with touch screen monitors have a radio frequency communication device 105. The personal computers 103, 104 with touch screen monitors are connected by wired and/or wireless communication technology to a scanner 106 and a printer 107, such as the wireless connections shown in FIG. 1. The personal computers 103, 104 with touch screen monitors are physically connected and wired and/or wirelessly connected to a pointing device 108, a keyboard 109, a biometric reader 110, and a bar code reader 111. The radio frequency communication device 105 communicates with portable user interface devices 112 and patient wristbands 113.

System users are identified by the biometric reader 110. Patients are identified by the bar code reader 111 and the wristbands 113. The unique identification extends to biomaterials collected from patients and stored in containers having bar codes or radio frequency transmitters for reading and identification by the readers described herein.

The system may also include a device known in the art which is able to record and process human voice as an alternative way of interacting with its users, using, for example, voice recognition hardware and/or software.

FIG. 2 is an example of a personal computer with a touch screen monitor. The central processing unit (CPU) or microprocessor and/or the memory may be attached to the monitor 201 and the keyboard 203, for example, over a wired and/or wireless connection locally or through a network, and/or the CPU and memory of the personal computer may be incorporated into the monitor and/or the keyboard 203. The principal way of interacting with the system is by use of the touch screen monitor 201. Identification of users is made by use of the biometric reader 202. Interaction with the system may also be made by use of the keyboard 203 and the pointing device 204, such as a mouse or electronic stylus. Identification of patients is made by use of the bar code reader 205.

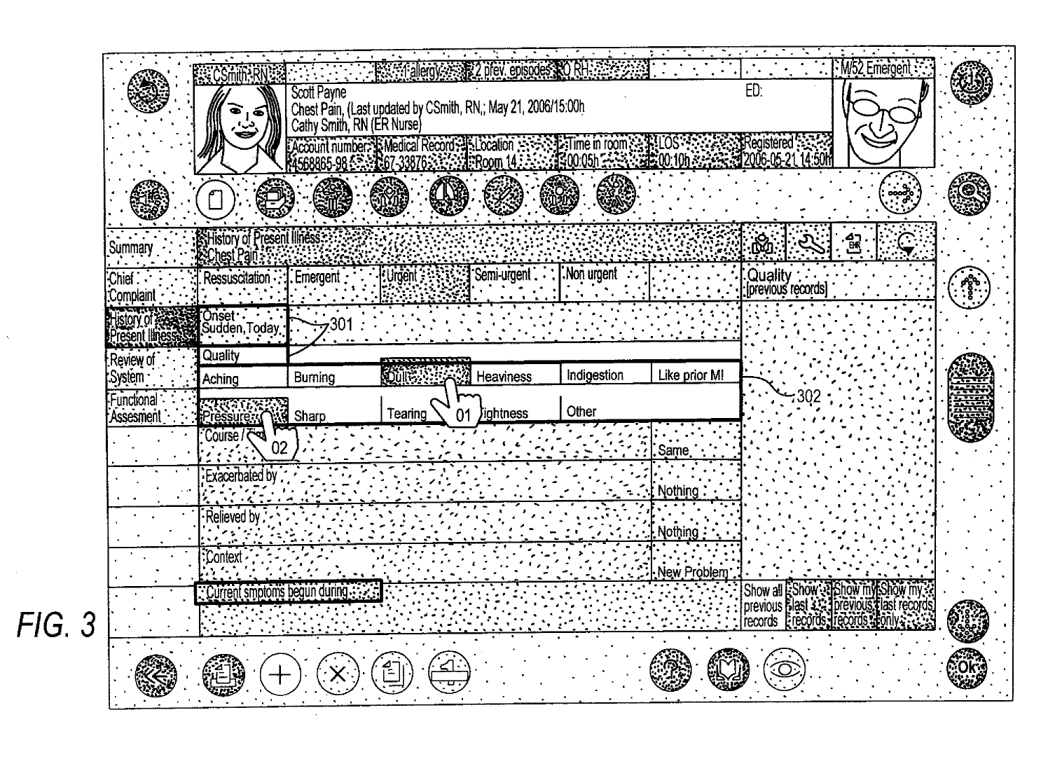

FIG. 3 is an illustration of a patient wristband, which includes a radio frequency communication device 301 for communication with the system. The patient wristband may also include a bar code tag 302 for permanent and unique identification of the patient and other entities in the system for tracking and identification. The patient wristband may also include biosensors 303 to allow remote monitoring of physiological parameters of the patient wearing the wristband.

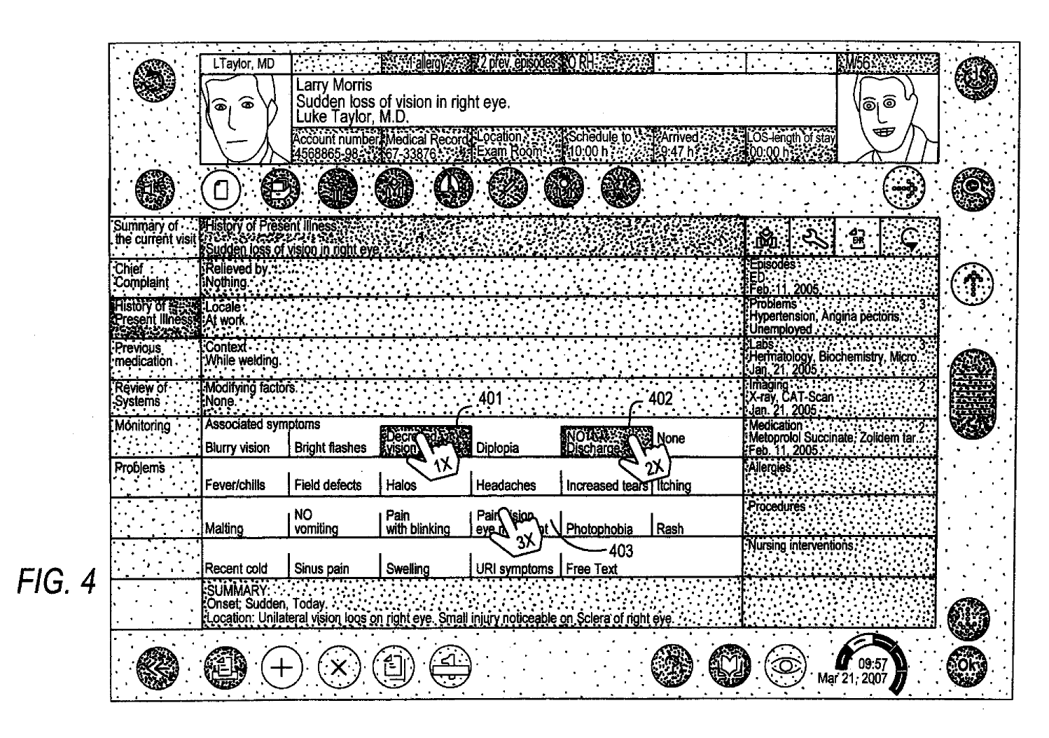

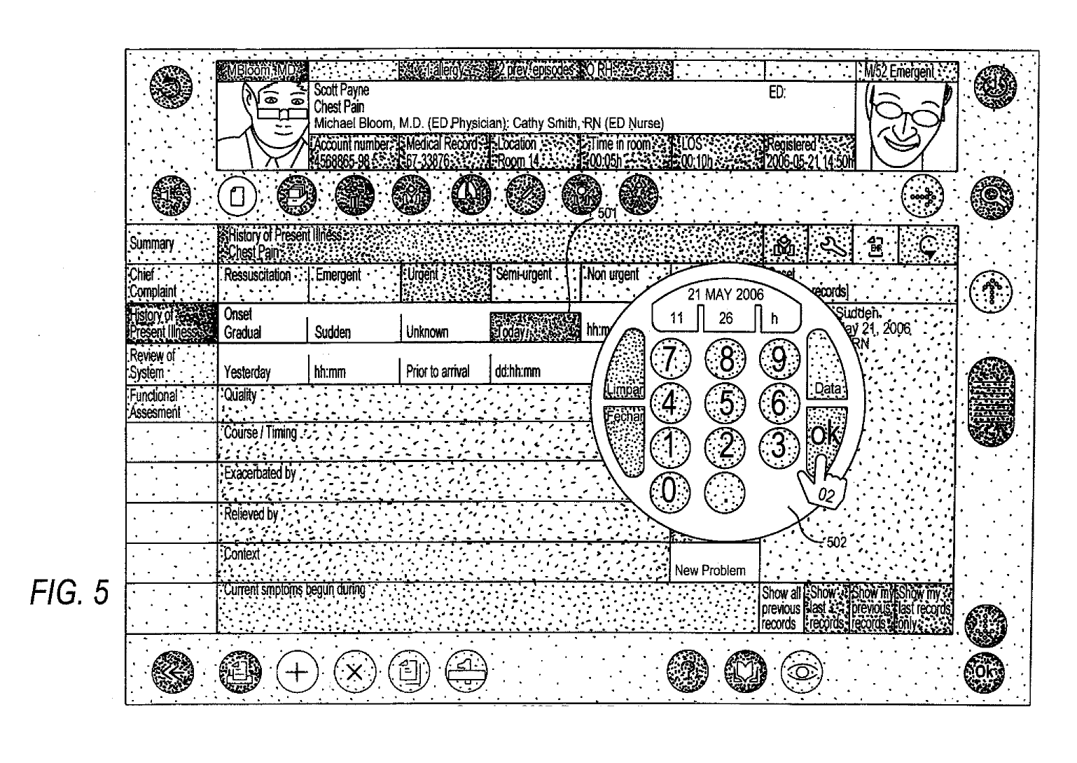

As shown in FIGS. 4-5, the system includes a graphical user interface displayed on the monitor 201 of the personal computers 103, 104. This interface is used for all aspects of system interaction, principally by use of the touch screen 201, but the keyboard 203 and the pointing device 204 are also used for specific functions.

FIG. 4 is an example of a display screen 401 displayed in the graphical user interface. The display screen 401 provides a template configured as a form listing records stored in the system including fixed data as well as input fields for a physician to enter and record the history of present illness of a patient whose chief complaint is chest pain. This display screen 401 presents both a photograph of the physician logged on to the system and of the patient.

The introduction of the history of present illness will create tasks for other users of the system. This is an illustration of the method whereby the sequential handling of all aspects of patient encounter are managed by the emission and receipt of alerts to and from devices during the different stages of patient encounters and amongst the different users. The interventions are registered in the system by the users, such as physicians, nurses, and laboratory technicians, and each intervention may trigger an alert regarding the next step in the sequence. This interaction is based on workflow principles whereby the complete clinical process has been written into the system, and the different tasks are assigned to the relevant users.

FIG. 5 is another example of a display screen of the graphical user interface. The virtual field 501 is an electronic health record viewer which allows the physician to consult at all times on the same screen of the user interface a summary of the patient's electronic health record including previous interventions, medical history, diagnoses, and treatment plans. The electronic health record viewer enables the updated and complete disclosure of patient data to the patient. The electronic health record viewer may be permanently displayed on the display screen.

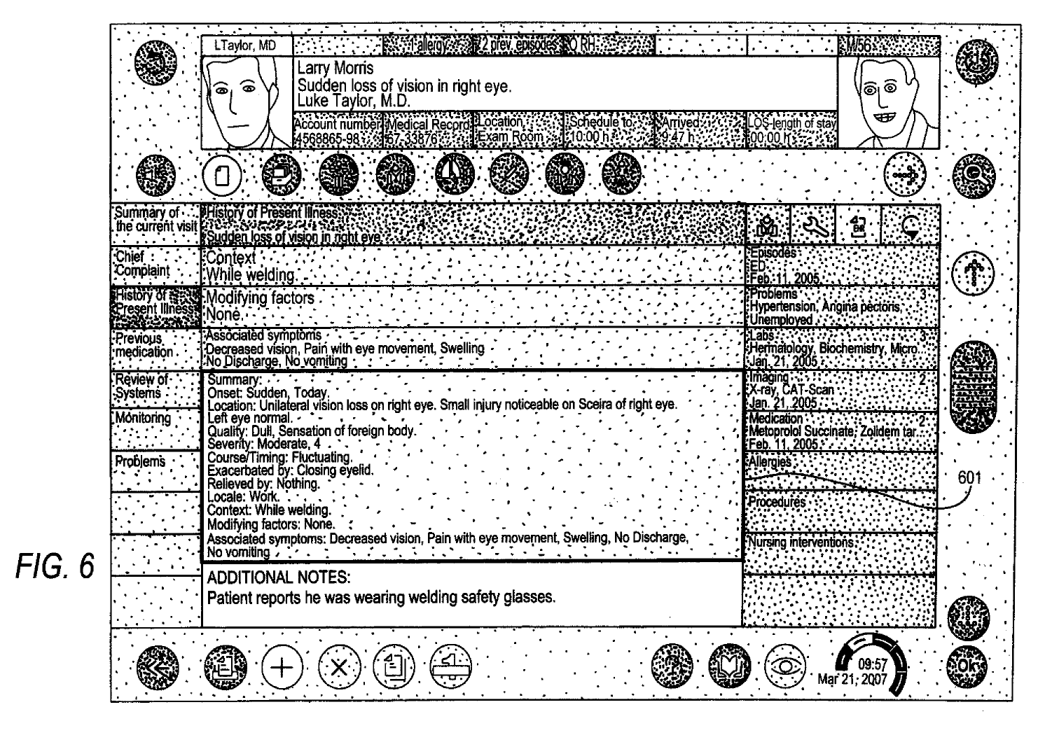

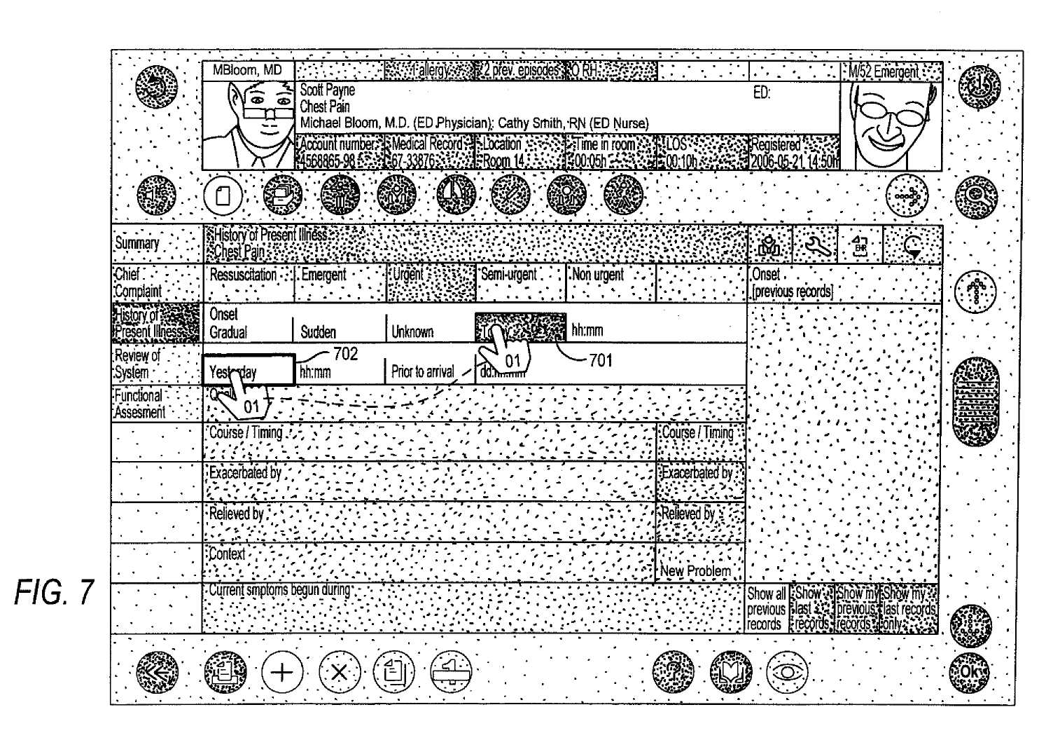

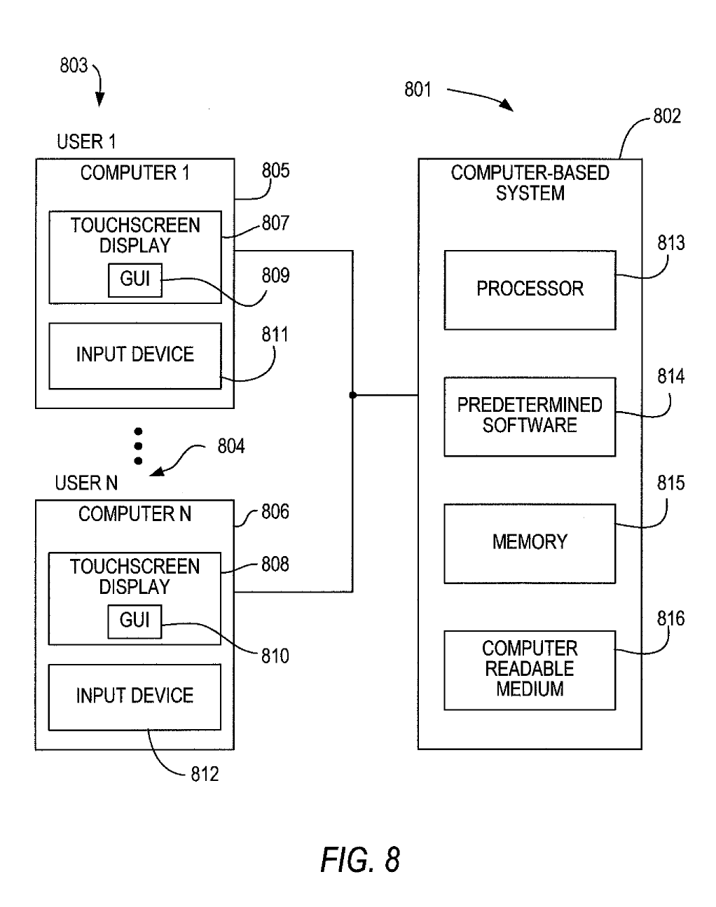

FIG. 6 is an illustration of the way workflow principles are written into the system, for example, in software implementing the present invention. The physician orders a specific test by introducing this request into the system, symbolized by the checkmark under the Order column. The system will determine which nurses are available, based on who is logged on to the system, their location and their workload, and emit an alert to the relevant nurse for collection of the biomaterials from the patient. The nurse will collect the biomaterials, with this action by the nurse symbolized by the hand image under the Collect column. The nurse will register this collection action in the system. This will in turn cause the emission of an alert to an ancillary staffer for transport of the biomaterials to the laboratory, with this transport action by the ancillary staffer symbolized by the hand image under the Transport column. Registration of the action by the ancillary staffer will cause the emission of an alert to the relevant laboratory technician to perform the test, symbolized by the hand image under the Lab Test column. When the laboratory test has been performed the laboratory technician will insert the test results into the system, with this action symbolized by the checkmark under the Result column. This action will trigger an alert to the physician that the requested test results are available for review.

All such order, collection, transport, lab test, and result data in the healthcare management system of the present invention are viewable with appropriate permission determined by specific categories of individuals, such as physicians, nurses, ancillary staffers, and technicians, with various access permissions symbolized by the eyes in FIG. 6.

The different applications of the system interact in the form of networks within and beyond the facilities of the healthcare provider. In this sense, the use of the system is not limited to a specific provider or to specific geographic locations and can accompany the different interactions of a single patient and/or of a single healthcare professional with multiple healthcare providers. This method facilitates making health records available to the corresponding patients.

The method also includes the integration with non-health specific enterprise modules such as billing, customer relationship management, accounting, enterprise resource planning as well as to legacy systems by use of standards such as DICOM and HL7 in accordance with IHE directives.

According to the present invention shown in FIGS. 1-6 and described herein, a system supports the provision of healthcare services, with the system including a plurality of devices; a computer program with a graphical user interface; a data warehouse; and means for permanently and uniquely identifying and physical tracking entities in the healthcare services using biometric authentication and tagging of the entities with at least one of a bar code and a radiofrequency identifier, with the identifying and tracking means being in communication with the plurality of devices, the computer program, and the data warehouse, in which the identified and tracked entities include all healthcare professionals, patients, and related collected biomaterials in the healthcare services.

The plurality of devices in the system may be any one or a combination of personal computers, touch screen monitors, keyboards, pointing devices, devices that are able to receive and communicate data using radio frequencies, biometric readers, bar code readers, servers, printers, scanners, and portable devices that receive and communicate data by radio frequencies, with the plurality of devices connected by at least one communications network. Other devices using the electromagnetic radiation such as infrared devices may also be used.

The computer program uses template-based records for documentation of a patient encounter of each patient engaging in the healthcare services. An electronic health record viewer operates with the computer program for viewing a healthcare record, in which the electronic health record viewer is permanently visible in the graphical user interface. The identifying and tracking means includes biosensors in a patient identification tag accomplishing remote monitoring of physiological parameters of the patient wearing the patient identification tag.

The present invention also includes a method for supporting the provision of healthcare services, with the method including the steps of handling in a sequential manner all aspects of a patient encounter by registering and editing electronically and in real time the clinical information resulting therefrom based on predetermined workflow principles; displaying the clinical information in multiple locations; defining user profiles for different based on the different responsibilities of the users, including healthcare professionals, involved in the patient encounter; and sending and receiving alerts to and from identification and tracking devices associated with the healthcare services during the different stages of patient encounter and among the different users.

The method may also include interconnecting a plurality of different communications networks to communicate between the identification and tracking devices. A software program, embodied on a computer readable medium, may incorporate and implement the disclosed method.

What is claimed is:

1. A system for supporting the provision of healthcare services, such system comprising:
a plurality of devices selected from the group consisting of: personal computers, touch screen monitors, keyboards, pointing devices, devices that are able to receive and communicate data using radio frequencies, biometric readers, bar code readers, servers, printers, scanners, and portable devices that receive and communicate data by radio frequencies, wherein the plurality of devices are connected by at least one communications network;
a computer program with a graphical user interface;
a data warehouse; and
means for permanently and uniquely identifying and physical tracking entities in the healthcare services using biometric authentication and tagging of the entities with at least one of a bar code and a radiofrequency identifier, with the identifying and tracking means being in communication with the plurality of devices, the computer program, and the data warehouse, wherein the identified and tracked entities include all healthcare professionals, patients, and related collected biomaterials in the healthcare services.

2. The system of claim 1, wherein the computer program uses template-based records for documentation of a patient encounter of each patient engaging in the healthcare services.

3. The system of claim 1, further comprising:
an electronic health record viewer operating with the computer program for viewing a healthcare record, wherein the electronic health record viewer is permanently visible in the graphical user interface.

4. The system of claim 1, wherein the identifying and tracking means includes:
biosensors in a patient identification tag accomplishing remote monitoring of physiological parameters of the patient wearing the patient identification tag.

5. A method for supporting the provision of healthcare services comprising:
handling in a sequential manner all aspects of a patient encounter by registering and editing electronically and in real time the clinical information resulting therefrom based on predetermined workflow principles;
displaying the clinical information in multiple locations;
defining user profiles for different based on the different responsibilities of the users, including healthcare professionals, involved in the patient encounter; and
sending and receiving alerts to and from identification and tracking devices associated with the healthcare services during the different stages of patient encounter and among the different users.

6. The method of claim 5, further comprising the step of:
interconnecting a plurality of different communications networks to communicate between the identification and tracking devices.

7. A software program, embodied on a computer readable medium, incorporating the method recited in claim 5.
